(19) United States
(12) Patent Application Publication
(10) Pub. No.: US 2022/0217442 A1
(43) Pub. Date: Jul. 7, 2022

(54) METHOD AND DEVICE TO GENERATE SUGGESTED ACTIONS BASED ON PASSIVE AUDIO

(71) Applicant: Lenovo (Singapore) Pte. Ltd., New Tech Park (SG)

(72) Inventors: Mark Patrick Delaney, Raleigh, NC (US); Arnold S. Weksler, Raleigh, NC (US); John Carl Mese, Cary, NC (US); Russell Speight VanBlon, Raleigh, NC (US); Nathan J. Peterson, Oxford, NC (US)

(21) Appl. No.: 17/142,696

(22) Filed: Jan. 6, 2021

(51) Int. Cl. H04N 21/442; G10L 15/26; H04N 21/485; H04N 21/488

(52) U.S. Cl. CPC H04N 21/44218; H04N 21/4882; H04N 21/485; G10L 15/26

(57) ABSTRACT

A computer implemented method, device and computer program device are provided that present audio/video (AV) content within a local environment. During presentation of the AV content, electronic viewer behavior (VB) data is collected for a user in the local environment. The VB data includes at least one of passive sound or action information generated by the user. The passive sound or action information relate to a user behavior context indicative of how the user experiences the AV content. A suggested action to be taken by one or more electronic devices is identified based on the VB data. The suggested action is presented on the one or more electronic devices and carried out.

### BACKGROUND

Embodiments of the present disclosure generally relate to automatically monitoring an audio environment for passive audio content and based thereon generating suggested actions.

Today, electronic devices (e.g., televisions, cellular phones, tablet devices, laptop computers) are utilized to stream a large variety of audio/video (AV) content. With the advent of streaming services, users are often multitasking or interacting with other individuals within a physical space while viewing the streaming AV content. For example, an individual may have a conversation with someone else while viewing streaming AV content, or step away from a TV, computer or other display while the streaming AV content continues to play (e.g., to get a drink, go to the bathroom and the like).

Further, while streaming AV content, a user may not hear or not fully understand part of the AV content and/or something another individual has said. When a user cannot hear or does not understand the AV content, this can detract from an overall entertainment experience, business environment and the like. As another example, while streaming AV content, another individual may say something that the user cannot hear, further detracting from the overall experience.

A need remains for improved methods, systems and computer program products to overcome the above noted concerns and other problems as explained herein.

### SUMMARY

In accordance with embodiments herein a method is provided that comprises, under control of one or more processors configured with executable instructions, presenting audio/video (AV) content through one or more electronic devices within a local environment; during presentation of the AV content, collecting electronic viewer behavior (VB) data for a user in the local environment, the VB data including at least one of passive sound information or passive action information generated by the user, the at least one of passive sound or action information related to a user behavior context indicative of how the user experiences the AV content; identifying a suggested action to be taken by the one or more electronic devices based on the VB data; presenting the suggested action on the one or more electronic devices; and carrying out the suggested action.

Additionally, or alternatively, the suggested action is carried out in response to a user input by the one or more electronic devices displaying the AV content. Additionally, or alternatively, the AV content includes video and audio content presented on the one or more electronic devices, the VB data including the passive sound information collected from a microphone of the one or more electronic devices, the identifying comprising comparing the passive sound information to one or more audio-based templates associated with corresponding suggested actions. Additionally, or alternatively, the AV content includes video and audio content presented on the one or more electronic devices, the VB data including the passive video information collected from a camera of the one or more electronic devices, the analyzing comprising comparing the passive video information to one or more image-based templates associated with corresponding suggested actions. Additionally, or alternatively, the suggested action includes at least one of i) changing a playback feature for the AV content, ii) changing a source of the AV content, or iii) presenting a text transcription of a statement by a second individual in the local environment. Additionally, or alternatively, the user behavior context is indicative of at least one of: i) a determination that a user is about to leave a room or other local environment where the AV content is being presented, ii) a determination that a user did not see or hear a portion of the AV content, iii) a determination that the user did not understand a portion of the AV content, iv) a determination that the user has a question regarding the AV content, or v) a determination that the user could not hear or understand a statement by another person present in the local environment.

Additionally, or alternatively, the method further comprises analyzing the passive sound information utilizing a natural language understanding algorithm to identify spoken content, the suggested action identified based on the spoken content identified from the NLU algorithm. Additionally, or alternatively, the presenting includes displaying indicia indicative of an action to be taken by the electronic device. Additionally, or alternatively, the method further comprises analyzing the VB data to determine whether the VB data represents content related VB data or non-content related VB data, and based thereon identifying one of a content related suggested action or non-content related suggested action. Additionally, or alternatively, the non-content related VB data includes spoken content from a second individual, and the non-content related suggested action includes displaying a textual transcription of the spoken content.

In accordance with embodiments herein, the system is provided that comprises a display configured to present AV content within a local environment; a user interface; a memory storing program instructions; one or more processors that, when executing the program instructions, are configured to: collect electronic viewer behavior (VB) data for a user in the local environment, the VB data including at least one of passive sound information or passive action information generated by the user, the at least one of passive sound or action information related to a user behavior context indicative of how the user experiences the AV content; identify a suggested action to be taken by one or more electronic devices based on the VB data; present the suggested action; and carry out the suggested action.

Additionally, or alternatively, the system further comprises a first electronic device that includes the display, user interface, memory and one or more processors. Additionally, or alternatively, the system further comprises first and second electronic devices, the second electronic device including the display configured to present the AV content, the first electronic device including a first processor from the one or more processors, the first processor configured to perform at least one of the collecting the VB data, identifying the suggested action, presenting the suggested action, or carrying out the suggested action. Additionally, or alternatively, the second electronic device includes a second processor configured to carry out the suggested action.

Additionally, or alternatively, the system further comprises a microphone communicating with the one or more electronic devices, the microphone configured to collect the passive sound information, as the VB data, the one or more processor configured to compare the passive sound information to one or more audio-based templates associated with corresponding suggested actions. Additionally, or alternatively, the system further comprises a camera communicating with the one or more electronic devices, the camera configured to collect the passive action information, as the VB data, the one or more processors configured to compare the passive video information to one or more image-based templates associated with the corresponding suggested actions. Additionally, or alternatively, the one or more processors are configured to carry out, as the suggested action, at least one of i) changing a playback feature for the AV content, ii) changing a source of the AV content, or iii) presenting a text transcription of a statement by a second individual in the local environment.

In accordance with embodiments herein, a computer program product is provided that comprises a non-signal computer readable storage medium comprising computer executable code to perform: presenting audio/video (AV) content through one or more electronic devices within a local environment; during presentation of the AV content, collecting electronic viewer behavior (VB) data for a user in the local environment, the VB data including at least one of passive sound information or passive action information generated by the user, the at least one of passive sound or action information related to a user behavior context indicative of how the user experiences the AV content; identifying a suggested action to be taken by the one or more electronic devices based on the VB data; presenting the suggested action on the one or more electronic devices; and carrying out the suggested action.

Additionally, or alternatively, the computer executable code is configured to identify the suggested action associated with the user behavior context that is indicative of at least one of: i) a determination that a user is about to leave a room or other local environment where the AV content is being presented, ii) a determination that a user did not see or hear a portion of the AV content, iii) a determination that the user did not understand a portion of the AV content, iv) a determination that the user has a question regarding the AV content, or v) a determination that the user could not hear or understand a statement by another person present in the local environment. Additionally, or alternatively, the computer executable code is configured to analyze the passive sound information utilizing a natural language understanding algorithm to identify spoken content, and identify the suggested action based on the spoken content identified from the NLU algorithm.

### BRIEF DESCRIPTION OF THE DRAWINGS

FIG. 1 illustrates a system 100 that tracks VB data in accordance with embodiments herein.

FIG. 2 illustrates a block diagram of the modules, catalogues, data and other information that may be stored within the memory in accordance with embodiments herein.

FIG. 3 illustrates a process for tracking VB data and identifying corresponding suggested actions in accordance with embodiments herein.

FIG. 4 illustrates a process for collecting different types of user specific templates in accordance with embodiments herein.

### DETAILED DESCRIPTION

It will be readily understood that the components of the embodiments as generally described and illustrated in the Figures herein, may be arranged and designed in a wide variety of different configurations in addition to the described example embodiments. Thus, the following more detailed description of the example embodiments, as represented in the Figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The terms “audio/video content” and “AV content” shall mean audio content and/or video content. For example, AV content may include only audio content with no video content, only video content with no audio content, or a combination of audio and video content.

The terms “command”, “device directed command” “wake-up” and “DD command”, when used to describe sounds and/or actions, shall mean sounds and/or actions by the user that are specifically intended to instruct an electronic device to wake-up and/or take a corresponding instructed action. For example, command sound information includes spoken preprogrammed commands to instruct the electronic device to take a corresponding preprogrammed action (e.g., play, pause, rewind, search, mute, change volume etc.). Command sound and/or action information is not limited to preprogrammed instructions, but instead also includes sounds and/or actions by the user directed to the electronic device to instruct the electronic device to take a known action. For example, while watching television or listening to music, command sound information includes statements by a user spoken into a remote control after pressing a “speech/question” button on the remote control (e.g., the user may press a speech/question button on a remote control and then state a word, phrase, question into a microphone of the remote control). As another example, command sound information may be entered into a personal digital assistant (PDA), smart phone, tablet device, laptop computer and the like. For example, when using an Alexa PDA or other similar type of PDA, a user may begin by stating a trigger word or phrase (e.g., “Alexa”, “Siri”), followed by a word, phrase, question, command and the like. The word, phrase, question, command and the like that is spoken to the electronic device after pressing a button or stating a trigger word or phrase, is intentionally directed by the user to the electronic device and attended by the user to instruct the electronic device to take a corresponding action, and thus represents a command.

The term “passive”, when used to describe sound information and/or action information, shall mean non-command sound information and/or non-command action information generated by the user that is not directed to an electronic device and is not intended to instruct the electronic device to take an action. For example, passive information (whether it be passive sound information or passive action information) shall represent sounds and/or actions by the user directed to and/or intended for other individuals present in the local environment, to the user himself or herself, and the like. As another example, a user may receive a notification (e.g., phone call text message, email, etc.) on a secondary electronic device, separate from the electronic device presenting the AV content, and the user may respond to the notification through the secondary electronic device (e.g., answer a phone call, speak a responsive text/email into the secondary electronic device). The phone conversation or spoken responsive text/email is not directed to the electronic device presenting the AV content, but instead is directed to another individual, and as such represents passive sound information. Nonlimiting examples of passive sound/action information include statements indicating a context of the user's behavior.

The term “content related”, when used in connection with describing passive sound information and/or passive action information, shall mean sound and/or action information related to the AV content being presented on the electronic device or capable of being presented on the electronic device. For example, while watching a movie, nonlimiting examples of content related passive sound information include words, phrases, statements, questions by a user to him or herself or to another person in the room that relate to the AV content and/or relate to other AV content that is available to be presented on the electronic device. Nonlimiting examples of passive sound information that may be captured by one or more microphones within the local environment include “what did he say”, “who is the director”, “what other movie did he play in”, “I need to use the restroom”, “I'm going to get another soda/snack”, “I wonder what the score of the Bills game is”, “who is winning the NASCAR race” and the like. The foregoing examples represent content related passive sound information as each statement is indicative of an aspect or context of the user's behavior that will influence the manner in which the user experiences AV content presently being presented or available to be presented (e.g., whether the user sees, hears, understands AV content of interest to the user). As another example, while watching a movie, content related passive action information may represent still or video data captured by a camera in the local environment detecting that the user is leaving the room where the AV content is displayed, has turned his/her back to the television and the like.

The term “non-content related”, when used in connection with describing passive sound information and/or passive action information, shall mean sound and/or action information unrelated to the AV content being presented (and unrelated to AV content available to be presented) on the electronic device. An example of non-content related passive sound information includes words, phrases, statements, questions, conversation between the user and another person. The second person may be present in the local environment or remote, such as when the user is talking to someone over the phone or through another electronic device. For example, while watching a movie, the user may be speaking to another person in the same room or in a different room, but have trouble hearing the other person, and thus say “I can't hear you”. As another example, when the second person is in a different room, a secondary electronic device near the second person may hear the statement made by the second person, after which the user indicated that the user could not hear the second person. In connection with embodiments herein, non-content related passive sound information may include the statement “I can't hear you”, in response to which, the action suggestion may include transcription of the statement by the second person and presentation of the transcribed statement on the electronic device showing the AV content (or on another electronic device in the presence of the user). As another example of non-content related passive sound information, and electronic device in the local environment may determine that a phone in the local environment is ringing, followed by the user answering the call “hello”. In accordance with embodiments herein, answering a phone call represents user behavior context indicating that the user will miss a portion of the AV content. In connection there with, a suggested action may be to turn down the volume, pause the AV content and the like. Optionally, a suggested action may include a combination of suggested actions, such as to turn the volume up or down in combination with turning close caption on or off. Optionally, when the system “hears” the same question more than once (e.g., what did he say?), The repetition of the same question may cause the system to automatically turn on close caption (or ask to turn on close caption).

The term “suggested action” shall mean information presented to the user indicative of an action that has been or may be taken by one or more electronic devices and the local environment. The suggested action may be presented on the same electronic device that would subsequently (or has already) performed the suggested action. Additionally, or alternatively, the suggested action may be presented on one electronic device, while a different electronic device will perform or has already performed the suggested action.

The term “local environment” shall mean an area in which AV content may be viewed and/or heard. Nonlimiting examples of the local environment include a room in which a television is playing, a conference room where videoconferencing equipment is set up, a portion of a home or office environment where the AV content may be seen or heard, and the like.

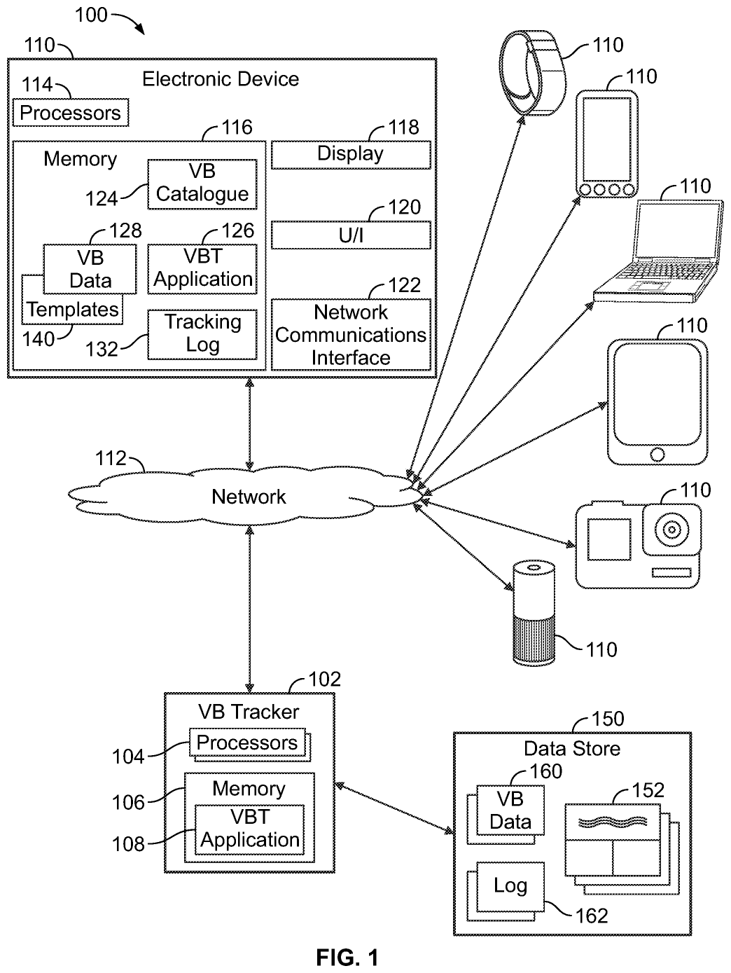

FIG. 1 illustrates a system 100 that tracks VB data in accordance with embodiments herein. The system 100 includes one or more electronic devices 110 that communicate with one another over a network 112. Optionally, the electronic devices 110 may communicate through a wholly or partially wired subsystem. The network 112 may represent the World Wide Web, a local area network, a wide area network and the like. The electronic devices 110 may represent various types of electronic devices including, but not limited to, smart phones, desktop or laptop computers, tablet devices, smart TVs, fixed cameras, portable or handheld cameras, recording devices, digital personal assistant (DPA) devices and the like. In addition, the electronic devices 110 may represent various types of devices configured to record audio and/or voice signatures, detect gestures and movements and the like.

At least one of the electronic devices 110 may be configured to implement VB tracking in accordance with embodiments herein. The electronic device 110 that is configured to implement VB tracking includes one or more processors 114, memory 116, a display 118, a user interface 120, a network communications interface 122, and various other mechanical components, electrical circuits, hardware and software to support operation of the electronic device 110. It is recognized that not all electronic devices 110 include a display, user interface, and the like. For example, a fixed or handheld camera or microphone may simply include camera or microphone related electronics and network circuitry to support communication to and from the camera or microphone. The display 118 is configured to present AV content within a local physical environment. As one example, the AV content may represent streamed content delivered over a network (e.g a streaming entertainment program, sporting event, video conferencing event and the like). Optionally, the AV content may not be streaming, but instead may be played from some other source.

The user interface 120 may include a variety of visual, audio, and/or mechanical devices. For example, the user interface 120 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the user interface 120 can include a visual output device such as a liquid crystal display screen, one or more light emitting diode indicators, an audio output device such as a speaker, alarm and/or buzzer, and a mechanical output device such as a vibrating mechanism. The display may be touch sensitive to various types of touch and gestures. As further examples, the user interface 120 may include a touch sensitive screen, a non-touch sensitive screen, a text-only display, a smart phone display, an audio output (e.g., a speaker or headphone jack), and/or any combination thereof. The user interface 120 permits the user to select one or more of a switch, button or icon in connection with various operations of the device 110.

The memory 116 may encompass one or more memory devices of any of a variety of forms (e.g., read only memory, random access memory, static random access memory, dynamic random access memory, etc.) and can be used by the processor 114 to store and retrieve data. The data that is stored by the memory 116 can include, but need not be limited to, operating systems, applications, and other information. Each operating system includes executable code that controls basic functions of the communication device, such as interaction among the various components, communication with external devices via a wireless transceivers and/or component interface, and storage and retrieval of applications and data to and from the memory 116. Each application includes executable code that utilizes an operating system to provide more specific functionality for the communication devices, such as file system service and handling of protected and unprotected data stored in the memory 116.

The network communications interface 122 provides a direct connection to other devices, auxiliary components, or accessories for additional or enhanced functionality, and in particular, can include a USB port for linking to a user device with a USB cable. Optionally, the network communications interface 122 may include one or more transceivers that utilize a known wireless technology for communication.

The memory 116 includes, among other things, a VBT application 126, VB catalogue 124, VB data 128, and one or more templates 140. The functionality of the VBT application 126 is described below in more detail. The templates 140 may include one or more types of templates that are associated with passive sound information, passive action information, user behavior context and corresponding suggested actions. More than one type of template (e.g., images, audio signatures, gestures) may be associated with a single user behavior context and suggested action, while different templates of the same type (e.g., words and phrases) may be associated with different users (e.g., one set of templates for each parent, a different set of templates for each child). For example, image-based templates may include still or video images associated with one user, where the images of the user are taken from different angles, with different lighting, with different cameras from different electronic devices and at different distances from the user. As another example, multiple sets of image-based templates may be stored in connection with multiple users.

The VB data 128 may include one or more types of passive sound information and/or passive action information based on the electronic device 110 that collects the VB data. The VB data may be collected over the network 112 from numerous types of electronic devices 110 that implement a tracking operation (also referred to as tracking devices). For example, one or more types of electronic devices 110 may collect image-based VB data and/or gesture-based VB data, while one or more other types of electronic devices 110 collect audio-based VB data and/or voice-based VB data.

As explained herein, the VBT application 126 utilizes the templates 140 to analyze the VB data 128 in order to identify user behavior context and corresponding suggested actions. The VBT application 126 may update a behavior log based on the analysis and provides feedback to the user concerning passive sound/action information, user behavior context and corresponding suggested actions. By way of example, the behavior log may include information concerning various passive sound/action information that was collected and a confidence indicator regarding a level of confidence that the passive sound/action information corresponded to a user behavior context and suggested action. In this manner, the user may be able to fine tune the process to be more accurate in correlating VB data with suggested actions.

In the foregoing example, the electronic device 110 implements the VBT application 126 locally on the same device that presents the AV content. For example, the electronic device 110 may represent a smart TV, entertainment system, laptop computer, tablet device, DPA device and the like.

Additionally, or alternatively, all or portions of the VBT application 126 may be implemented remotely on a remote resource, denoted in FIG. 1 as a VB tracker 102. The object tracker 102 may perform limited operations, such as manage storage and creation of templates. The VB tracker 102 may provide access to one or more memory 150, and/or implement the VBT application. The VB tracker 102 communicates with electronic devices 110 through one or more networks 112 to provide access to templates 152 and to implement processes described herein. The VB tracker 102 may represent another electronic device in or proximate the same local environment in which the electronic device 110 is presenting the AV content. Additionally, or alternatively, the VB tracker 102 may represent a server or other network based computing environment. The VB tracker 102 may represent a single computer system or a collection of computer systems located at a common location or geographically distributed.

The VB tracker 102 includes one or more processors 104 and memory 106, among other structures that support operation of the VB tracker 102. In accordance with embodiments herein, the VB tracker 102 may receive the passive sound/action information collected by one or more other electronic devices (e.g., one or more of the smart watch, cell phone, laptop computer, tablet device, camera, PDA denoted in FIG. 1). The VB tracker 102 may then analyze the VB data to identify one or more user behavior context, identify a corresponding suggested action and return the suggested action to another electronic device (e.g., electronic device 110) for presentation to the user. Additionally, or alternatively, the VB tracker 102 may perform fewer operations, but instead, operate more as a VB data depository and source to maintain updates to the VBT application, templates, updates to an NLU process, updates to an image analysis process and the like. It is recognized that the object tracker 102 performs other operations, not described herein, such as operations associated with maintaining resources and the like.

The memory 150 may store the templates 152 organized in various manners and related to a wide variety of users, types of local environments, types of AV content, types of electronic devices presenting the AV content and the like. The templates 152 may be organized and maintained within any manner of data sources, such as data bases, text files, data structures, libraries, relational files, flat files and the like. The templates 152 include various types of templates corresponding to a variety of users, local environments, types of AV content, types of electronic devices presenting the AV content, types of electronic devices collecting VB data, and the like. Optionally, the memory 150 may store the VB data 160, such as when the VB tracker 102 receives tracking passive sound/action information from electronic devices 110 that are performing collecting operations. Optionally, the memory 150 may store behavior logs 162, such as when the VB tracker 102 analyzes passive sound/action information and identifies corresponding suggested actions.

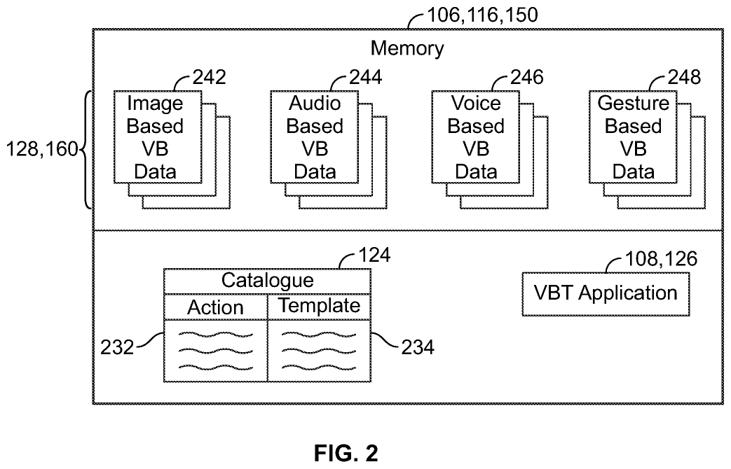

FIG. 2 illustrates a block diagram of the modules, catalogues, data and other information that may be stored within the memory 106, 116, 150 in accordance with embodiments herein. The VBT application 108, 126 includes program instructions accessible by the one or more processors to direct a processor to implement the methods, processes and operations described herein including, but not limited to the methods, processes and operations illustrated in the Figures and described in connection with the Figures. The VBT application 108, 126 includes one or more modules that operate in connection the various functions and features as described herein.

The memory 106, 116, 150 stores various types of VB data (generally denoted at 128, 160), such as image-based VB data 242, audio-based VB data 244, voice-based VB data 246 and gesture-based VB data 248. The memory 106, 116, 150 also stores the VB catalogue 124 which maintains templates 234 associated with passive sound information and/or associated with passive action information, along with corresponding suggested actions 232 and corresponding user behavior context. As explained herein, the templates 234 may be based on different types of passive sound and action information, such as images, audio, voice content, gestures and the like. In accordance with embodiments herein, an NLU algorithm or other automatic language analysis algorithm may analyze passive sound information and convert words, phrases and the like to text. The text words, phrases and the like may then be compared to text based templates.

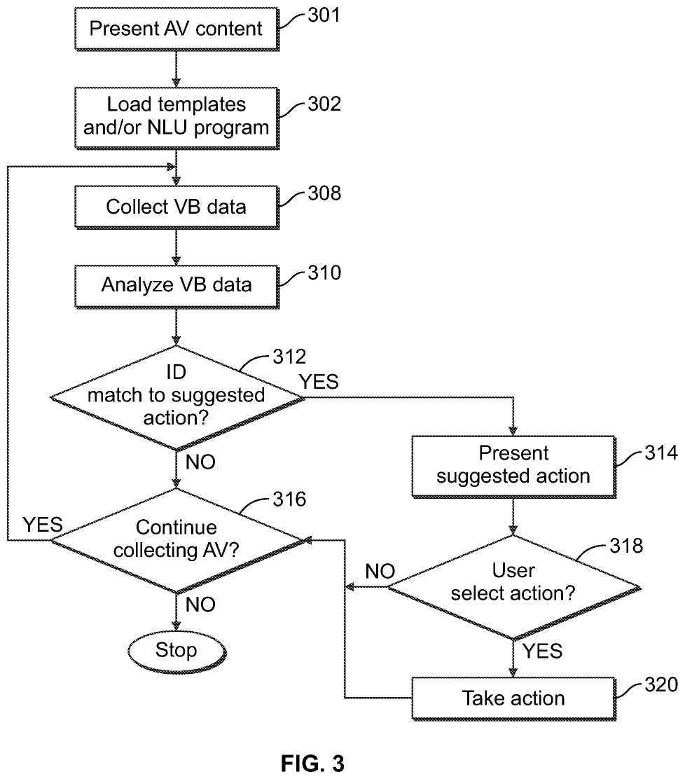

FIG. 3 illustrates a process for tracking VB data and identifying corresponding suggested actions in accordance with embodiments herein. The operations of FIG. 3 are carried out by one or more processors 114 of one or more electronic devices 110 in response to execution of program instructions, such as in the VBT application 126, and/or other applications stored in the memory 116. Additionally, or alternatively, the operations of FIG. 3 may be carried out by the processors 104 within one or more servers at the VB tracker 102 in response to execution of program instructions, such as in the VBT application 108.

At 301, one or more processors of one or more electronic devices present audio/video (AV) content within a local environment. For example, the AV content may be streamed from a network service, such as when streaming entertainment content, performing videoconferencing and the like. For example, a television may present programming, such as a movie, sporting event and the like. As another example, one or more PDAs may play music. As another example, a smart phone, tablet device, laptop computer and the like may present a virtual meeting, such as utilizing the Zoom conferencing application, WebEx conferencing application and the like. One or more users view and/or listen to the AV content (streaming or non-streaming) being presented within the local environment. Nonlimiting examples of the local environment include a room in which a television is playing, a conference room where videoconferencing equipment is set up, a portion of a home or office environment where the AV content may be seen or heard, and the like.

At 302, one or more processors load/activate one or more programs configured to manage collection and analysis of VB data. For example, the one or more processors may load/activate a natural language understanding (NLU) program and/or one or more templates related to collecting and analyzing electronic viewer behavior (VB) data in connection with a user who is viewing the AV content. For example, the NLU may review passive sound information collected by one or more microphones within the local environment, such as words and phrases spoken by the user (e.g., “what did they say?”, “I need to go to the bathroom”, I can't hear you”). Additionally, or alternatively, the one or more processors may load/activate an image recognition/tracking program to track passive action information in connection with a user who is viewing the AV content. For example, the image recognition/tracking program may be configured to track movement of a user, gestures by a user and the like. The one or more processors may track certain individuals, as users, and/or track any individual present in the local environment, as a user.

Additionally, or alternatively, the one or more processors may load templates associated with certain words, phrases, statements, gestures, actions and the like that maybe identified from the passive sound information and/or passive action information. For example, predefined or baseline templates may be preprogrammed or programmed over time, where the templates are associated with certain user behavior context and related suggested actions. For example, a template associated with a particular user behavior context (e.g., leaving the room during a movie) may include one or more audio templates that include certain words or phrases that may be stated by a user in connection with getting up and leaving a room. Additionally, or alternatively, one or more sets of templates may be uploaded to an electronic device 110 from a database or server (e.g., tracker 102).

At 308, the one or more processors collect VB data for a user in the local environment. The VB data includes at least one of passive sound information or passive action information generated by one or more users. For example, the one or more processors may utilize one or more microphones to collect listen for words, phrases or conversations. The microphone may be provided with the electronic device displaying the AV content. Additionally, or alternatively, the microphone may be provided with a separate electronic device proximate to the user. Additionally, or alternatively, the microphone may be provided within a separate electronic device that is remote from the electronic device presenting the AV content (e.g., a phone, PDA or other device in

Additionally, or alternatively, the one or more processors may utilize one or more cameras to collect still or video images of actions by the user. In connection with image recognition, embodiments herein may utilize cameras to collect image-based VB data. The cameras may be provided in various manners. For example, a camera may be within a smart phone, tablet device, laptop, smart TV, a wearable device (e.g., a go pro device, Google glasses) and the like. Additionally, or alternatively, fixed cameras may be positioned in select areas within a local environment where AV content is generally presented (e.g., a home living room, a kitchen, an office, etc.). Additionally, or alternatively, an in-home video surveillance system may be utilized to collect the VB data.

At 310, the one or more processors analyze the VB data to identify a suggested action associated with one or more user behavior context. User behavior context are indicative of how a user has or will experience the AV content. Nonlimiting examples of user behavior context include i) a determination that a user is about to leave the room or other local environment where the AV content is being presented, ii) a determination that a user did not see or hear a portion of the AV content, iii) a determination that the user did not understand a portion of the AV content, iv) a determination that the user has a question regarding the AV content, or v) a determination that the user could not hear or understand a statement by another person present in the local environment (e.g., because the audio is too loud for a movie), and v) a determination that the user is interested in other programming (e.g., a score of a football game, a NASCAR race, etc.). Nonlimiting examples of suggested actions include: i) changing a playback feature for the AV content, ii) changing a source of the AV content, or iii) presenting a text transcription of a statement by a second individual in the local environment.

The electronic device, that captures the VB data, may perform all or a portion of the analysis of the VB data. For example, one or more processors of a smart TV or smart phone may collect passive sound and/or action information from a microphone and/or camera and analyze the passive sound and action information to identify one or more suggested actions for a corresponding user behavior context. Additionally, or alternatively, one or more primary electronic devices may capture some or all of the passive sound and/or action information and pass the information to one or more secondary electronic devices which then perform the analysis, and identify a suggested action. The same or a different electronic device may then present the suggested action and the same or a yet further different electronic device may carry out the suggested action.

Additionally, or alternatively, the passive sound and/or action information collected may not be specific to a particular individual, but instead concern any individual who is present in the local environment where the AV content is presented. For example, an NLU algorithm may analyze any speech detected, regardless of the person speaking, and transcribe the speech to text or otherwise identify a user behavior context from the speech. As another example, image analysis software may be utilized to detect when any individual in the local environment leaves or moves about within the local environment.

Additionally, or alternatively, different users may be tracked at the same time or at different times. The VB data collection process may include a training session to enable identification of a user's voice and/or image. For example, the one or more processors may record various words, phrases or conversations during a training interval in order to achieve voice and/or facial recognition of the user. Additionally, or alternatively, the VB data collection process may be implemented in connection with multiple users at the same time or at different times. For example, each family member may undergo a training session to enable the VB data collection process to identify the family members voice and/or image. During presentation of AV content, a chosen one of the users may be tracked. For example, when a family is watching a movie, one or both parents may be tracked as the users. At a different time, when children are watching TV, without the parents present, one or more of the children may be tracked as the user. In a work environment, when multiple employees are located in a common conference room and are participating in an AV conference, a manager or person running the meeting may be designated as the user.

Optionally, at 310, the one or more processors may analyze the VB data to determine whether the VB data is passive or represents a device directed command. For example, a catalog may be maintained of device directed commands (e.g., turn on, turn off, go to channel xx, turn volume up, turn volume down). At 310, the one or more processors may apply an NLU algorithm or other speech recognition algorithm to determine whether the VB data includes a device directed command. As explained herein, device directed commands refer to sounds and/or actions by a user that are specifically intended to instruct an electronic device to take a corresponding instructed action. When the VB data is determined to not correspond to a device directed command, the one or more processors declare the VB data to represent passive non-command information, such as passive sound information and/or passive action information.

Optionally, at 310, the one or more processors may analyze the VB data to determine whether the VB data is content related or non-content related VB data. For example, content related VB data refers to sounds and actions related to the AV content that is being presented (e.g., a movie) or is capable of being presented (e.g a programmer sporting event on another channel). As another example, non-content related VB data refers to sounds and/or actions unrelated to the AV content, such as a conversation between individuals present in the local environment or conversation over an electronic device. In accordance with embodiments herein, it may be desirable to distinguish between content related VB data and non-content related VB data, in connection with determining which electronic devices are available to perform the suggested action. For example, when collecting content related VB data, the electronic device presenting the AV content (e.g., the television) may be the electronic device best suited to perform a suggested action (e.g., pause, rewind, add close caption, change volume). Alternatively, when collecting non-content related VB data, a secondary electronic device, differing from the electronic device presenting the AV content, may be better suited to perform the suggested action. For example, when a first person near a television cannot hear a second person in another room, a secondary electronic device proximate the second person in the other room may be better suited to listen to statements made by the second person, in order for the statements to be transcribed and presented to the first person. The text version of the speech may be presented in a pop-up window on the same device is displaying the AV content or on a different device.

At 312, the one or more processors determine whether the analysis at 310 indicates that the VB data matches a suggested action. As one example, a natural language understanding algorithm may analyze words and phrases by the user and convert the words or phrases into text strings. The text strings may then be compared to one or more text templates. As another example, an image recognition algorithm may analyze still or video images captured by a camera in the local environment to identify gestures and/or movement of the user. The gestures and/or movement may be compared to one or more templates, such as to determine when a user has turned his/her back to a television, has averted his/her gaze to another item in the room and is no longer looking at the source of the AV content, has gotten out of a chair or off the couch and is walking out of the room, and the like.

Each template is associated with one or more user behavior context indicative of how a user is currently or may experience the AV content, as well as one or more corresponding suggested actions. For example, a template associated with words, phrases and/or actions indicating that the user is about to leave the room would be associated with a user behavior context indicating that the user is about to miss a portion of the AV content. The template would similarly be correlated with a suggested action, such as to pause the AV content. As another example, a template may associate words, phrases and/or actions indicating that a user did not understand a portion of the AV content. The template would be associated with the user behavior context indicating that the user is not understanding the AV content, as well as with a suggested action to rewind the AV content to replay a portion thereof. As another example, a template may be associated with a user behavior context indicating that the user was unable to hear something said by another individual present in the local environment. The template would be associated with the user behavior context indicating that the user desires, but cannot hear, something stated by another individual, as well as a suggested action to pause the AV content, turned down the volume of the AV content, transcribe what the second individual said and present a textual transcription of the individual's statement on a television, smart phone or other electronic device visible to the user.

The one or more processors may generate a correlation rating between the VB data and one or more templates, where the correlation rating is indicative of a degree to which the VB data and template match. When the correlation rating exceeds a predetermined threshold, the processors may determine that a match occurred and that the VB data corresponds to the object within the one or more template. Various alternative object recognition techniques may be utilized to identify objects of interest from VB data.

Optionally, at 312, the VB data may be compared to a single template, or multiple templates related to a single type of data (e.g., only image-based, only audio-based, etc.). Additionally, or alternatively, two or more types of VB data may be analyzed to determine corresponding correlation ratings obtained in connection there with. The correlation ratings from the two or more types of VB data may then be separately compared to corresponding thresholds and/or combined (e.g., in a weighted sum) and compared to a threshold to determine a confidence that the target object of interest was identified. For example, audio-based VB data and templates may be compared and the processors may determine that a set of keys have been placed on a kitchen countertop. However, the audio signals may not be sufficiently distinct to distinguish between various sets of keys within a single-family. Image-based VB data and templates may be then compared to determine which set of keys were placed on the kitchen countertop.

Optionally, the image-based VB data and templates may be utilized to merely identify the person placing the keys on the table or countertop (e.g., a male adult, female adult, male teenager, female teenager). Based on the gender and age determined from the image-based VB data, the processors may determine that the keys correspond to a particular individual's vehicle (e.g., the father's, mother's, teenage son, teenage daughter).

As a further example, gesture-based VB data and templates may be analyzed to indicate that a user has removed something from a pocket. In some instances, the gesture-based VB data may be specific enough to indicate that the user has removed something from a particular pocket (e.g., a side pocket on cargo pants, a right rear pocket). A gesture-based template may include information indicating that the user only stores his wallet in the right rear pocket, and us any gesture-based VB data indicating the removal of anything from a particular pocket may be labeled as a particular target object of interest. Consequently, the gesture-based data may be sufficient to identify the target object as a user's wallet.

Additionally, or alternatively, the gesture-based VB data may be less specific, indicating merely that the user has removed something from a pocket without knowing which pocket. Optionally, the gesture-based template may not assume that everything in a particular pocket is the object of interest. Hence, the gesture-based VB data, when analyzed alone, may exhibit a low level of confidence concerning a target object. Optionally, audio, voice and/or image-based VB data and templates may be utilized to further identify the object removed from the pocket.

As a further example, voice signals collected by an electronic device may be analyzed at 312 for select spoken content (e.g., words or phrases). When the spoken content matches or at least is similar to a voice-based template, an object of interest may be identified. A level of confidence may be assigned to the identification of the object of interest based on the correlation between the spoken content and the corresponding templates.

When the VB data matches user behavior context and a suggested action, flow moves to 314. When the BV data does not match a user behavior context or suggested action, flow moves to 316.

At 314, the one or more processors present the suggested action to the user. The suggested action may be displayed on the same electronic device that is presenting the AV content, or on another electronic device. For example, a display of the electronic device may display indicia indicative of an operation that the electronic device will take. The indicia may represent alphanumeric information, such as asking the question or making a statement to describe in operation. Optionally, the indicia may represent one or more graphical symbols indicative of the operation suggested. For example, a smart TV may present a suggested action, such as displaying a pop-up window that says, “Do you want to pause the movie?”, “Do you want to rewind the movie?”, “Do you want to know who directed the movie?”, “Do you want to turn down/up the volume?”, “Do you want close captions turned on/off?”, “Would you like to check the score of the football game?” and the like. As another example, when the user behavior context indicates that the user cannot hear another person speak, the suggested action could be displayed as “Do want to turn down the volume?” and/or the suggested action could be to display a text transcription of what the other person said. For example, the user could be watching movie or sporting event in a living room, while another person in the kitchen says something to the user. A smartphone, PDA or other electronic device in the kitchen may hear the person speak, transcribe the statement into text and wirelessly transmit the text string to the smart TV. The smart TV or other electronic device of the user would then display the text in a pop up window.

At 318, the one or more processors determine whether a user input has been received that selects or declines the suggested action. When the user input selects the suggested action, flow moves to 320. When the user input declines the suggested action (or no user input is entered in a predetermined period of time), flow moves to 316. The user input may be entered in various manners such as through a remote control of a TV or user interface of the same or a different electronic device that is presenting the AV content and/or same or different electronic device that presents the suggested action. Additionally, or alternatively, the user input may be spoken by the user, a gesture or other action by the user, or any other input indicating that the user desires to take the suggested action.

Additionally, or alternatively, the suggested action may be managed as an action that will automatically occur unless the user enters an input to cancel the suggested action. For example, a pop-up window may say “I will pause the movie unless you say otherwise”, “I will rewind the movie 20 seconds unless you say no”, “Tyler Reddick is in 1^{st} place”, “I will turn down/up the volume”, “I will turn closed-captions on/off”, “I will change the station to the football game” and the like. If the user does not enter the appropriate response, the suggested action is automatically taken after a predetermined period of time. Thus, in some instances, the suggested action will be taken automatically without any user input.

When flow moves to 320, the one or more processors carry out the suggest action. For example, the electronic device may pause or rewind a movie, change a channel to a sporting event or other program of interest to the user, turn the volume up/down and the like. When the suggested action is to answer a question, no further action is taken. When the suggested action is to display a transcription of what a person said in another room, no further action is taken. The action may be taken by the same or a different electronic device as the device that presents the suggested action. For example, the suggested action may be displayed on a phone, but a TV or cable TV box may carry out the action.

Additionally, or alternatively, another suggested action may be to change a mode of display, such as to add picture in picture (PIP), where the main programming is displayed on the main portion of the display, while another channel is displayed in the PIP window. As another example, scoring updates for a sporting event may be showed in a PIP box. Additionally, or alternatively, the suggested action may include pushing the updates for the sporting event to a secondary electronic device, such as the user's phone. As another example, the suggested action may push other information to the secondary device, such as a transcription of a statement by a person from another room, in answer to a question (e.g., who was the director) and the like.

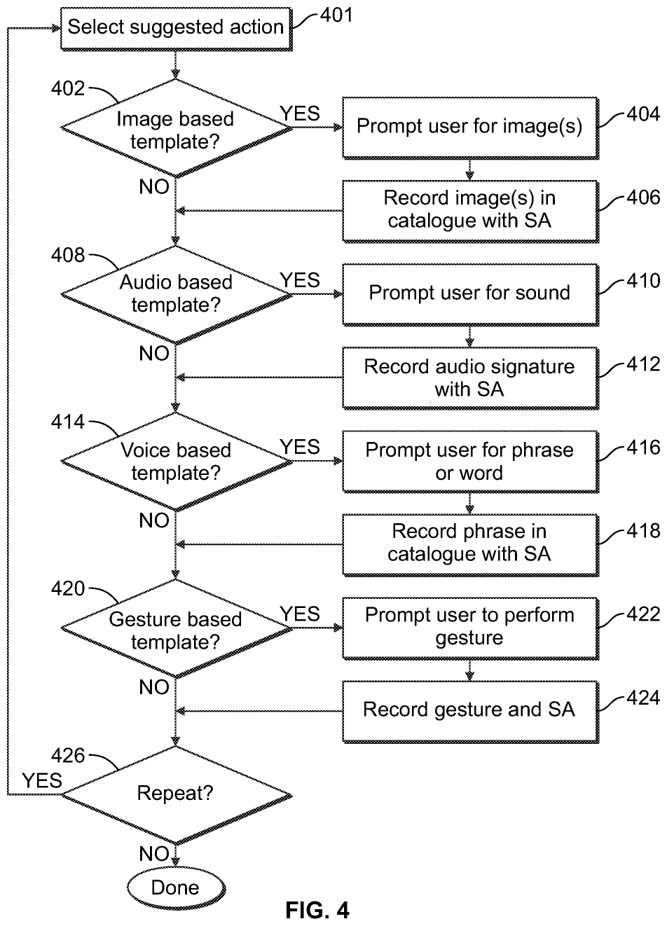

FIG. 4 illustrates a process for collecting different types of user specific templates in accordance with embodiments herein. While the operations of FIG. 4 are illustrated as a common continuous flow, it is recognized that anyone or more of the different subsections may be implemented alone or in different combinations. For example, one or more of the different types of templates may be collected alone or in combination with one or more of the other types of templates.

At 401, the one or more processors identify a suggested action that may be taken by the electronic device presenting the AV content. For example, a display may present a menu of potential suggested actions and a user is allowed to select a suggested action from the menu. Additionally, or alternatively, the one or more processors may automatically choose a suggested action and inform the user (e.g., display a message) that one or more templates are about to be recorded/programmed in connection with the suggested action. Additionally, or alternatively, a user may begin a programming sequence in which the one or more processors track a series of one or more device control actions taken by the user. For example, a user may begin a programming sequence, followed by selecting a mute button on a remote control, and then in the programming sequence to designate the selection of the mute button as the “suggested action”, for which one or more templates are to be developed. As another example, a user may enter a programming sequence through which the user selects a series of buttons on the remote control to identify a particular program or sporting event, and then designate the programming sequence as the “suggested action” to identify the corresponding programmer sporting event.

At 402, the one or more processors determine whether an image-based template is to be collected. If so, flow moves to 404. Otherwise, flow moves to 408. At 404, the one or more processors prompt the user for one or more images (e.g., still images or video images) related to the selected suggested action. For example, the collection operation may involve the user taking pictures or video while the user is in different positions, sitting, standing, facing different directions, etc. For example, the user may be allowed to act-out one or more passive actions.

At 406, the images are recorded in the catalog in connection with the corresponding suggested action associated with the user behavior context.

At 408, the one or more processors determine whether an audio-based template is to be collected. If so, flow moves to 410. Otherwise, flow moves to 414. At 410, the one or more processors prompt the user for one or more audio recordings related to a select suggested action (e.g., clapping hands, snapping fingers). At 412, the audio recordings are recorded in the catalog in connection with the corresponding suggested action. The recordings for the passive sound made by a user may be taken at different angles, from different distances, and with different background noises.

At 414, the one or more processors determine whether a voice-based template is to be collected. If so, flow moves to 416. Otherwise, flow moves to 420. At 416, the one or more processors prompt the user for one or more words or phrases related to the suggested action. For example, the voice-based templates may represent phrases spoken by a user concerning the AV content (e.g., what did they say), words or phrases spoken to another person (e.g., what did you say). At 418, the voice-based templates are recorded in the catalog in connection with the corresponding suggested action.

At 420, the one or more processors determine whether a gesture-based template is to be collected. If so, flow moves to 422. Otherwise, flow moves to 426. At 422, the one or more processors prompt the user to perform one or more gestures related to the suggested action. At 424, the voice-based templates are recorded in the object catalog in connection with the corresponding suggested action.

At 426, the one or more processors determine whether to repeat one or more of the foregoing operations in connection with the same or another suggested action. If so, flow returns to 401. Otherwise, the process ends. In connection with the foregoing operations, one or more types of templates may be generated and stored in a catalog with corresponding suggested actions. The various types of templates may be stored in a common catalog. Additionally, or alternatively, separate catalogs may be maintained in connection with image, audio, voice and gesture-based templates.

### Closing Statements

As will be appreciated by one skilled in the art, various aspects may be embodied as a system, method or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the Figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

The units/modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally, or alternatively, the units/modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The units/modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the subject matter described herein is not limited in its application to the details of construction and the arrangement of components set forth in the description herein or illustrated in the drawings hereof. The subject matter described herein is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

1. A method, comprising:
under control of one or more processors configured with executable instructions;
presenting audio/video (AV) content through one or more electronic devices within a local environment;
during presentation of the AV content, collecting electronic viewer behavior (VB) data for a user in the local environment, the VB data including passive action information generated by the user, the passive action information related to a user behavior context indicative of how the user experiences the AV content;
identifying a suggested action to be taken by the one or more electronic devices based on the VB data;
presenting the suggested action on the one or more electronic devices; and
carrying out the suggested action.

2. The method of claim 1, wherein the suggested action is carried out in response to a user input by the one or more electronic devices displaying the AV content.

3. (canceled)

4. The method of claim 1, wherein the AV content includes video and audio content presented on the one or more electronic devices, the VB data including passive video information collected from a camera of the one or more electronic devices, the analyzing comprising comparing the passive video information to one or more image-based templates associated with corresponding suggested actions.

5. The method of claim 1, wherein the suggested action includes at least one of i) changing a playback feature for the AV content, ii) changing a source of the AV content, or iii) presenting a text transcription of a statement by a second individual in the local environment.

6. The method of claim 1, wherein the user behavior context is indicative of at least one of: i) a determination that a user is about to leave a room or other local environment where the AV content is being presented, ii) a determination that a user did not see or hear a portion of the AV content, iii) a determination that the user did not understand a portion of the AV content, iv) a determination that the user could not hear or understand a statement by another person present in the local environment.

7. (canceled)

8. The method of claim 1, wherein the presenting includes displaying indicia indicative of an action to be taken by the electronic device.

9. The method of claim 1, further comprising analyzing the VB data to determine whether the VB data includes content related VB data or non-content related VB data, and based thereon identifying one of a content related suggested action or non-content related suggested action.

10. The method of claim 9, wherein the non-content related VB data includes spoken content from a second individual, and the non-content related suggested action includes displaying a textual transcription of the spoken content.

11. A system, comprising:
a display configured to present audio/video (AV) content within a local environment;
a user interface;
a memory storing program instructions;
one or more processors that, when executing the program instructions, are configured to:
collect electronic viewer behavior (VB) data for a user in the local environment, the VB data including passive action information generated by the user, the passive action information related to a user behavior context indicative of how the user experiences the AV content;
identify a suggested action to be taken by one or more electronic devices based on the VB data;
present the suggested action; and
carry out the suggested action.

12. The system of claim 11, further comprising a first electronic device that includes the display, user interface, memory and one or more processors.

13. The system of claim 11, further comprising first and second electronic devices, the second electronic device including the display configured to present the AV content, the first electronic device including a first processor from the one or more processors, the first processor configured to perform at least one of the collecting the VB data, identifying the suggested action, presenting the suggested action, or carrying out the suggested action.

14. The system of claim 13, wherein the second electronic device includes a second processor configured to carry out the suggested action.

15. (canceled)

16. The system of claim 11, further comprising a camera communicating with the one or more electronic devices, the camera configured to collect the passive action information, as the VB data, the one or more processors configured to compare the passive video information to one or more image-based templates associated with the corresponding suggested actions.

17. The system of claim 11, wherein the one or more processors are configured to carry out, as the suggested action, at least one of i) changing a playback feature for the AV content, ii) changing a source of the AV content, or iii) presenting a text transcription of a statement by a second individual in the local environment.

18. A computer program product comprising a non-signal computer readable storage medium comprising computer executable code to perform:
presenting audio/video (AV) content through one or more electronic devices within a local environment;
during presentation of the AV content, collecting electronic viewer behavior (VB) data for a user in the local environment, the VB data including passive action information generated by the user, the passive action information related to a user behavior context indicative of how the user experiences the AV content;
identifying a suggested action to be taken by the one or more electronic devices based on the VB data;
presenting the suggested action on the one or more electronic devices; and
carrying out the suggested action.

19. The computer program product of claim 18, wherein the computer executable code is configured to identify the suggested action associated with the user behavior context that is indicative of at least one of: i) a determination that a user is about to leave a room or other local environment where the AV content is being presented, ii) a determination that a user did not see or hear a portion of the AV content, iii) a determination that the user did not understand a portion of the AV content, iv) a determination that the user has a question regarding the AV content, or v) a determination that the user could not hear or understand a statement by another person present in the local environment.

20. (canceled)

21. The method of claim 1, further comprising communicating with a camera with the one or more electronic devices, and collecting the passive action information, as the VB data, and comparing the passive video information to one or more image-based templates associated with the corresponding suggested actions.

22. The computer program product of claim 18, wherein the computer executable code is configured to collect the passive action information from a camera, as the VB data, and compare passive video information from the camera to one or more image-based templates associated with the corresponding suggested actions.

23. The method of claim 1, wherein the wherein passive sound information is not within the VB data.

24. The method of claim 18, wherein passive sound information is not within the VB data.
